(19) United States
(12) Patent Application Publication
(10) Pub. No.: US 2013/0003105 A1
(43) Pub. Date: Jan. 3, 2013

(54) PRINTING APPARATUS AND PRINTING SYSTEM

(75) Inventor: Akihiro YAMADA, Nagoya-shi (JP)

(73) Assignee: BROTHER KOGYO KABUSHIKI KAISHA, Aichi-ken (JP)

(21) Appl. No.: 13/417,738

(22) Filed: Mar. 12, 2012

(30) Foreign Application Priority Data
Jun. 28, 2011 (JP) 2011-142776

(51) Int. Cl. G06K 15/02

(52) U.S. Cl. 358/1.14

(57) ABSTRACT

A printing apparatus is provided including: a storage section which stores the print jobs, a printing section which performs printing to execute the print jobs by accepting a print instruction for the print jobs stored in the storage section, a priority determination section which determines a print priority for the print jobs stored in the storage section when the amount of free space in the storage section is not more than a threshold value, a transmission section which transmits a print job to an external device if the priority determination section has determined that print job to be lower in the print priority than other print jobs, and a deletion section which deletes the print job transmitted by the transmission section from the storage section.

### CROSS REFERENCE TO RELATED APPLICATION

The present application claims priority from Japanese Patent Application No. 2011-142776 filed on Jun. 28, 2011 the disclosure of which is incorporated herein by reference in its entirety.

### BACKGROUND OF THE INVENTION

1. Field of the Invention

The present invention relates to a printing apparatus and a printing system and, in more detail, relates to a printing apparatus and a printing system which executes print jobs through a process of storing the print jobs into a storage section of the printing apparatus and accepting a print instruction from users.

2. Description of the Related Art

Conventionally, there have been remote printing techniques for carrying out printing by sending print jobs to a print apparatus from a terminal device such as a PC, a cellular phone, or the like. In such kind of remote printing techniques, for example, the printing apparatus stores the received print jobs and stands by for commencing the printing process later on the occasion that the user has issued a print instruction to the printing apparatus to execute the print jobs. In recent years, due to the spread of public wireless LAN service, the remote printing techniques described hereinabove have been widely utilized. For example, by sending print jobs in advance to a printing apparatus at public facilities such as train stations, airports and the like, the user can obtain the printed materials later at the place of printing.

For example, Japanese Patent Application Laid-Open No. 11-216915 discloses a remote printing technique similar to those described hereinabove. In particular, this document discloses a technique of registering jobs with passwords to the printer and commencing the printing process for the jobs on the occasion of inputting the passwords to the printer having registered the jobs. Further, Japanese Patent Application Laid-Open No. 11-216915 discloses that if there is sufficient free space in a storage section of the printer, then the data in page-description language are converted into image data, and the image data are stored, while if there is not sufficient free space in the storage section of the printer, then the data in page-description language are stored.

### SUMMARY OF THE INVENTION

There is a problem as below in the conventional remote printing techniques described hereinabove. Due to the limited amount of memory in the storage section of a printer, if a plurality of print jobs have already been registered, or if a print job ready to be registered has a large data size, then it is possible to fail to register any new print job. However, print jobs may include both high and low priority jobs. Therefore, there is room for improving the technique of registering print jobs (the technique of storing print jobs into the storage section).

Accordingly, the present teaching is configured to solve the above problem in the conventional techniques. An object of the present teaching is to provide a printing apparatus and a printing system capable of storing print jobs into a storage section of the printing apparatus.

According to a first aspect of the present teaching, there is provided a printing apparatus which is communicably connected to an external device that is independent from the printing apparatus and which performs printing on a medium based on a print job, the printing apparatus including:

a storage section which is configured to store a plurality of print jobs;

a printing section which is configured to perform printing to execute a print job of the print jobs stored in the storage section by accepting a print instruction for the print job;

a priority determination section which is configured to determine a print priority for each of the print jobs stored in the storage section under a condition that an amount of free space in the storage section is not more than a threshold value;

a transmission section which is configured to transmit, to the external device, a low-priority print job of the print jobs of which priority is determined, to be lower than that of other print jobs among the print jobs by the priority determination section; and

a deletion section which is configured to delete, from the storage section, the low-priority print job transmitted by the transmission section.

The printing apparatus of the present teaching stores print jobs into a storage section, and starts printing for the print jobs by accepting a print instruction for the print jobs. Further, on detecting that the amount of free space in the storage section is less than or equal to a predetermined threshold value, the printing apparatus of the present teaching determines a print priority to be high or low for each of the print jobs stored in the storage section. Determination of the print priority to be high or low is based on priority information added to the jobs such as time and date of storage, owner of job and the like. Then, the printing apparatus of the present teaching sends the print jobs determined to be low in priority to an external device and, thereafter, deletes the sent print jobs from the storage section. The external device may be either the device sending the print job or other devices than the former.

That is, when the amount of free space in the storage section becomes less, the printing apparatus of the present teaching allocates the free space in the storage section for storing new print job by sending the print job of low print priority among those stored in the storage section to the external device, and deleting the sent print job from the storage section. By virtue of this, it is possible to reduce the possibility of failing to register new print job while avoiding deletion of print jobs of high print priority. Further, since the print job deleted from the storage section is stored in the external device in advance, there is little risk in losing the print job.

According to a second aspect of the present teaching, there is provided a printing system which is configured to start printing to execute print jobs by accepting a print instruction for the print jobs, the printing system including:

a printing apparatus which performs printing for the print jobs; and

an external device which is configured to communicates with the printing apparatus,

wherein the printing apparatus includes:
a storage section which is configured to store the print jobs;
   a priority determination section which is configured to compare the print jobs stored in the storage section with a new print job to determine whether or not the print jobs stored in the storage section are higher in print priority than the new print job under a condition that the amount of free space in the storage section becomes not more than a predetermined value because of receiving the new print job;
   a transmission section which is configured to transmit a low-priority print job to the external device in a case in which the priority determination section has determined that the low-priority print job to be lower in the print priority than other print jobs among the print jobs;
   a deletion section which is configured to delete the low-priority print job sent by the transmission section from the storage section;
   a transmission determination section which is configured to determine whether or not there is a swap-out job which is the low-priority print job transmitted by the transmission section, after executing the print jobs stored in the storage section; and
   a request section which is configured to request the external device to send the swap-out job under a condition that the transmission determination section has determined that there is the swap-out job; and
      wherein the external device includes: an external storage section which is configured to store the swap-out job, and a job transmission section which is configured to transmit the swap-out job stored in the external storage section to the printing apparatus according to the request from the request section.

According to a third aspect of the present teaching, there is provided a printing apparatus which performs printing on a medium based on a print job, including:

a communicating section which is configured to communicate with an external apparatus which is independent from the printing apparatus;

a storage section which is configured to store a plurality of print jobs;

a printing section which is configured to perform printing onto the medium based on each of the print jobs; and

a control section which is configured to control the communicating section, the storage section and the printing section;

wherein the control section is configured to perform steps under a condition that the communicating section receives a new print job, the steps including:
checking an amount of free space in the storage section;
selecting, based on a predetermined condition, a lowest-priority print job of which priority is the lowest in the print jobs stored in the memory section, under a condition that the amount of free space in the storage section is not greater than a threshold value;
transmitting the lowest-priority print job to the external apparatus by the communicating section; and
deleting, from the storage section, the lowest-priority print job transmitted to the external apparatus.

According to the present teaching, there are realized a printing apparatus and a printing system capable of storing print jobs into a storage section of the printing apparatus.

### BRIEF DESCRIPTION OF THE DRAWINGS

FIG. 1 is a block diagram showing an electrical configuration of a printer in accordance with the present teaching;

FIG. 2 is a block diagram showing an operational outline of a printing system in accordance with the present teaching;

FIG. 3 is a flowchart showing a procedure of a job reception process in accordance with a first embodiment of the present teaching;

FIG. 4 is a flowchart showing a procedure of a printing process in accordance with the first embodiment;

FIG. 5 is a flowchart showing a procedure of an expiration time management process in accordance with a second embodiment of the present teaching; and

FIG. 6 is a flowchart showing a procedure of a job reception process in accordance with the second embodiment.

### DESCRIPTION OF THE PREFERRED EMBODIMENTS

Hereinbelow, referring to the accompanying drawings, explanations will be made in detail with respect to preferred embodiments of a printing apparatus in accordance with the present teaching. The preferred embodiments apply the present teaching to a printer connected to a server.

<Configuration of the Printer>

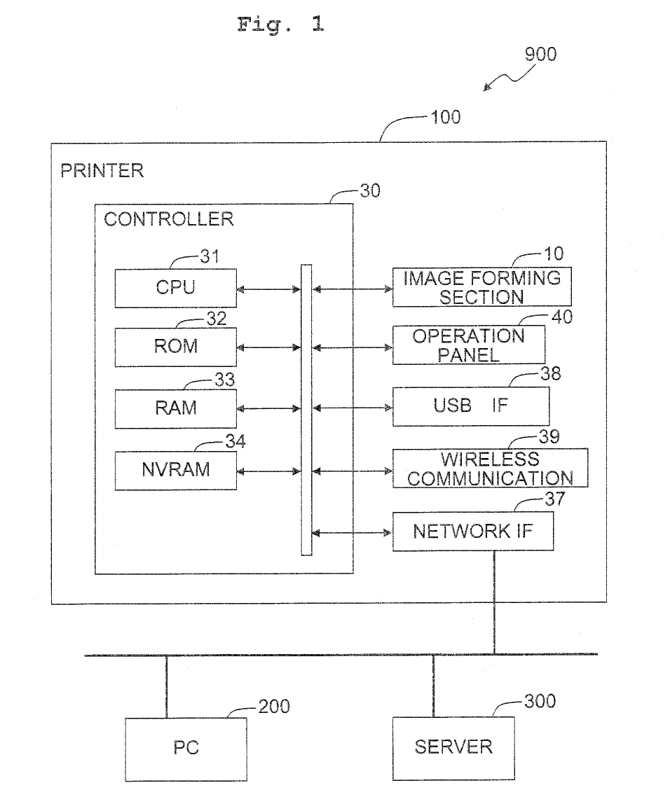

As shown in FIG. 1, a printer 100 of the preferred embodiments (an example of the printing apparatus) is provided with a controller 30 (an example of the control section) including a CPU 31, a ROM 32, a RAM 33, and an NVRAM 34 (Non Volatile RAM). Further, the controller 30 is electrically connected with an image formation section 10 which prints images on printing paper, an operation panel 40 which displays operating conditions and accepting user's input operations, a network interface 37, a USB interface 38, and a wireless communication interface 39.

The ROM 32 stores firmware which is control programs for controlling the printer 100, and a variety of setting and initial values. The RAM 33 and NVRAM 34 are utilized as working areas for reading out the various control programs, or as storage areas for temporarily storing image data.

The CPU 31 (an example of the priority determination section, transmission section, deletion section, transmission determination section and restoring section) controls each component of the printer 100 according to the control programs read out from the ROM 32 and the signals sent from various sensors. The processing result of the CPU 31 is stored into the RAM 33 or the NVRAM 34.

The network interface 37, the USB interface 38 and the wireless communication interface 39 are interfaces enabling the printer 100 to communicate with other devices (external devices). The printer 100 receives print jobs sent from other devices through these interfaces. In the preferred embodiments, the printer 100 is capable of communications with a PC 200 (personal computer) and a server 300 through the network interface 37. The printer 100 may as well communicate with other devices through the USB interface 38 and/or the wireless communication interface 39.

Further, the image formation section 10 (an example of the printing section) may adopt either an electrophotographic method or an ink jet method as the image formation method, as long as it is capable of printing images on printing paper. Further, the image formation section 10 may either be capable of color print or be dedicated to black-and-white print.

Further, the operation panel 40 has various buttons for accepting user's inputs, and a liquid crystal display for displaying character information. As the various buttons, for example, there are a button for instruction to carry out a print, and a cancel button for instruction to cancel a print operation.

<Configuration of the Printing System>

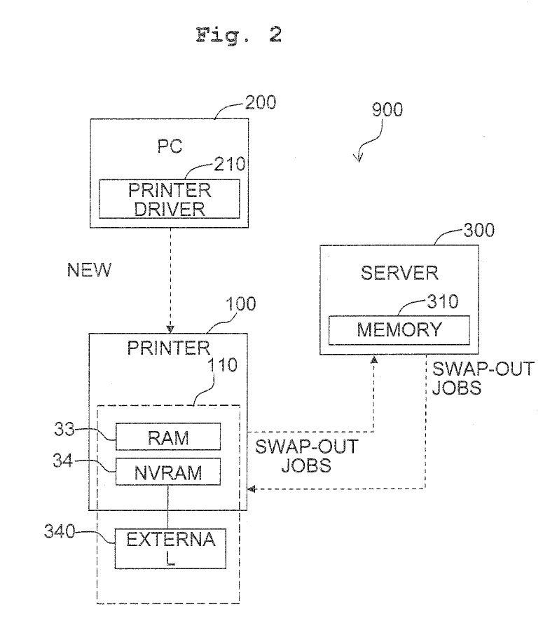

Next, with reference to FIG. 2, explanations will be made with respect to the configuration and operation of a printing system 900 including the printer 100. Further, in FIG. 2, in order to simplify the explanations, the printing system 900 is constituted only by the printer 100, the PC 200, and the server 300. However, a printing system in accordance with the present teaching is not limited to such kind of constitution. For example, it may be connected with any information processing devices other than the printer 100, the PC 200, and the server 300.

In the printing system 900, each time the PC 200 accepts a print instruction from the user, a printer driver 210 generates a print job. Then, the print job is sent from the PC 200 to the printer 100. Further, the print job includes a print data which is the print object, as well as information for identifying each print job, information for identifying the user who has inputted the job, and a print expiration time. Further, the print expiration time may be set through user's input. Alternatively, the print expiration time may be set by the printer driver 210 in an automatic manner.

On receiving a print job, the printer 100 stores the print job into a memory area 110 (an example of the storage section) allocated for storing print jobs. The memory area 110 is allocated in the RAM 33 or the NVRAM 34 or the both. Further, when connected with an external memory 340 such as a USB memory, an external HDD or the like, it may include the memory area allocated in the external memory. Further, the print data stored in the memory area 110 may be either image information data (such as PDL data and PDF data) before being converted into a bitmap image data or image conversion data after being converted as bitmap image data. Alternatively, the memory area 110 may as well store both image information data and image conversion data.

After storing the print job into the memory area 110, the printer 100 comes into a standby mode waiting for input of a print instruction for the print job. That is, the printer 100 does not start printing for the print job at the stage of having received the print job.

After inputting the print job to the printer 100, the user moves to where the printer 100 is placed, and then operates the printer 100 via the operation panel 40 to input the print instruction for the print job stored in the memory area 110. On accepting the print instruction, the printer 100 starts printing for the print job corresponding to the print instruction. The printer 100 stores the print job for the print object into the memory area 110 of the printer 100. Therefore, the printer 100 is able to start printing earlier compared with printers which receive the print job for a print object each time after the print instruction is issued from the server 300 and the like.

Further, at the time of receiving a new print job (to be referred to as a “new job” hereinbelow) sent in from the PC 200, if there is not sufficient free space in the memory area 110, then the printer 100 extracts a print job or print jobs from the existing print jobs stored in the memory area 110 other than the new job, and swaps out (temporary moves) the extracted print jobs (to be referred to as “swap-out jobs” hereinbelow) to a memory 310 of the server 300. That is, it sends the swap-out jobs to the server 300, and then deletes the swap-out jobs from the memory area 110. By virtue of deleting the swap-out jobs, areas for storing all new jobs are thus secured in the memory area 110.

Further, when a predetermined condition is satisfied, the server 300 sends back the swap-out jobs stored in the memory 310 to the printer 100. The predetermined condition is, for example, such as a transmission command has been inputted from the user to the server 300, the server 300 has received a transmission request sent in from the printer 100, etc. The transmission request from the printer 100 is outputted, for example, when a predetermined amount or more of free space can be allocated in the memory area 110.

### First Embodiment

### Job Reception Process

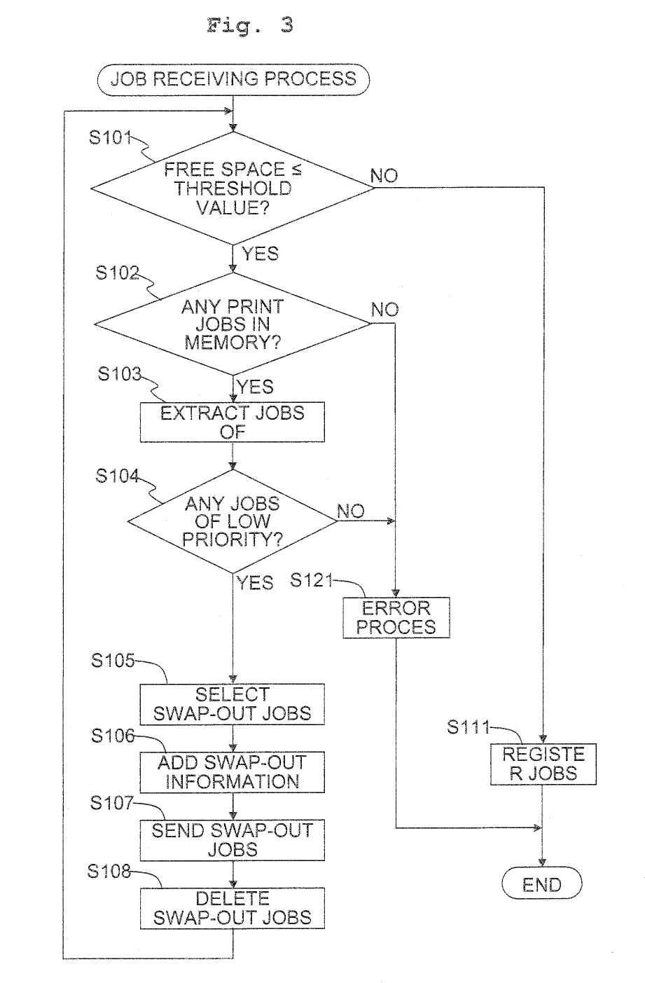

Next, explanations will be made with respect to control of the printing system 900 described hereinabove. First, referring to the flowchart of FIG. 3, an explanation will be made with respect to a job reception process (an example of the priority determination section, transmission section and deletion section) which is the process carried out when the printer 100 has received any new jobs. The CPU 31 carries out the job reception process on the occasion of the printer 100 having received any new jobs.

In the job reception process, the printer 100 (the CPU 31, to be exact) first determines whether or not the amount of free space in the memory area 110 is less than or equal to a threshold value (S101). If the amount of free space is more than the threshold value (S101: No), then it is possible to determine that free space is sufficiently allocated to store the received new jobs, which are thereby storable in the memory area 110. At this time, the printer 100 receives all new jobs and stores the same into the memory area 110 (S111). After storing the received new jobs into the memory area 110, the job reception process is ended.

If the amount of free space is less than or equal to the threshold value (S101: Yes), then the new jobs may possibly be not storable into the memory area 110. Therefore, the printer 100 determines whether or not any print jobs are stored in the memory area 110 (S102).

If no print jobs are stored (S102: No), then it is not possible to select print jobs to become swap-out jobs. Therefore, an error process is carried out (S121) for it is not possible to store new jobs anymore into the memory area 110. The error process outputs a command to the PC 200 to display an error message on the screen of the PC 200 indicating that, for example, print jobs cannot be registered. Further, the printer 100 may store an error log. Further, if some of the new jobs have already been stored in the memory area 110, then those new jobs are deleted from the memory area 110. After the error process, the job reception process is ended.

On the other hand, if print jobs are stored (S102: Yes), then the printer 100 extracts print jobs lower in print priority than the received new print jobs from the print jobs stored in the memory area 110 (S103; an example of the priority determination section).

As a method for determining the degree of print priority, the following method is exemplified. For instance, it is feasible to compare the (remaining) times before the print expiration time becomes due between the new jobs and the print jobs stored in the memory area 110, and determine the jobs with shorter remaining time to be high in print priority. A shorter remaining time renders a shorter period of time during which print remains possible, thereby posing a high risk that print may become impossible because of surpassing the print expiration time. Hence, it is feasible to determine a higher print priority for a shorter remaining time.

Further, for example, the CPU 31 determines whether or not the users are the same between the print jobs stored in the memory area 110 and the new jobs, and determines the print jobs of the same user, if any, to be lower in print priority than those of different users. It is possible for the print jobs lower in print priority to become swap-out jobs. Further, if some other user's print jobs were swapped-out, this other user would suffer inconvenience. Therefore, it is desirable to let the print jobs of the same user be swap-out jobs. For the above reason, it is possible to determine the print jobs of the same user to be lower in print priority than those of different users.

For example, if it is possible to set a print priority period in the printer 100, then it is possible to determine print jobs stored within the print priority period to be higher in print priority than those stored beyond the print priority period. There are cases that in a particular period of time (right after arrival for work, for example), print jobs get crowded due to users' strong desire for printing. Therefore, the printer 100 may be provided with a print priority period for uniformly raising the print priority of print jobs. Then, the print jobs received during the print priority period may not be swapped-out to the server 300.

Further, if the new jobs are the same as the swap-out jobs sent to the server 300, then the new jobs may be determined to be higher in print priority than the print jobs stored in the memory area 110. In the case of reregistering the swap-out jobs sent to the server 300, it is highly possible that the user strongly desires to carry out printing for those print jobs. Therefore, it is preferable to raise the priority. Further, it is possible to determine the new jobs to be the same as the swap-out jobs by, for example, adding information indicating retransmission to the new jobs. Further, if the printer 100 has control over the information of transmitting print jobs, then the determination may be made based on the transmission information.

In extracting print jobs of low priority (S103), based on these determination conditions, the print priorities are compared between the new jobs and each of the print jobs stored in the memory area 110. Further, in extracting print jobs of low priority (S103), determination may be made either based on one determination condition or by combining a plurality of determination conditions. In the case of combining a plurality of determination conditions, for example, even if there is only one condition for the print priority to be lower than the new jobs, the relevant print job may be extracted as the print job lower in print priority than the new jobs.

Next, the printer 100 determines whether or not even one print job has been extracted in the step S103 of extracting print jobs of low priority (S104). If no print jobs are extracted (S104: No), then it is determined that no print jobs may become swap-out jobs. In this case, because it is possible to determine the new jobs to be the lowest in print priority, the error process (S121) is carried out, and then the job receiving process is ended.

If print jobs are extracted in the step S103 of extracting print jobs of low priority (S104: Yes), then print jobs are selected from the extracted print jobs to become swap-out jobs (S105). As a method for selecting the print jobs, for example, it is possible to select the print jobs with the longest (remaining) time before the print expiration time is expired. Further, the printer 100 may as well select swap-out jobs in a random manner or display a list of the extracted print jobs to let the user select the print jobs to become swap-out jobs. Further, either one or a plurality of swap-out jobs may be selected.

After selecting print jobs to become swap-out jobs (S105), swap-out information is added to the selected swap-out jobs (S106). The swap-out information corresponds to at least one of the information for indicating the swap-out jobs due to insufficient memory, and the time of swap-out. Further, if the swap-out jobs are sent to the server 300 from a plurality of printers 100, then it is necessary to indicate from which printers 100 the swap-out jobs are sent, respectively. Hence, information for identifying devices of sending swap-out jobs may be added as the swap-out information. That is, information may be added to indicate from which printer 100 a print job is swapped-out. These pieces of information are added to the header information of the swap-out jobs. By virtue of this, it is possible to directly determine any print jobs to be swap-out jobs or not from the header information of the print jobs, whereby the printer 100 does not need to retain information of the swap-out jobs. Then, the swap-out jobs with the added swap-out information are sent to the server 300 (S107; an example of the transmission section). On receiving the swap-out jobs, the server 300 stores the swap-out jobs into the memory 310 of the server 300, and then notifies the printer 100 of the completion of storage.

On receiving the notification from the server 300, the printer 100 deletes the swap-out jobs from the memory area 110 (S108; an example of the deletion section). The aspect of deletion may be either erasion of the data or a permission of overwriting the data.

Because of the deletion of swap-out jobs from the memory area 110 (S108), the amount of free space is increased in the memory area 110. Hence, the printer 100 redetermines whether or not the amount of free space in the memory area 110 is less than or equal to the threshold value (S101). When the amount of free space in the memory area 110 is more than the threshold value (S101: No), then the new jobs are registered into the memory area 110 (S111). When the amount of free space in the memory area 110 is still less than or equal to the threshold value (S101: Yes), then the printer 100 proceeds to determining whether or not any print jobs are stored in the memory area 110 (S102) and the succeeding steps to repeat the transmission and deletion of swap-out jobs.

That is, the printer 100 repeats the transmission and deletion of swap-out jobs until the amount of free space in the memory area 110 is allocated to be more than the threshold value. Then, after the free space is secured, the new jobs are registered into the memory area 110, and then the job receiving process is ended.

<Printing Process>

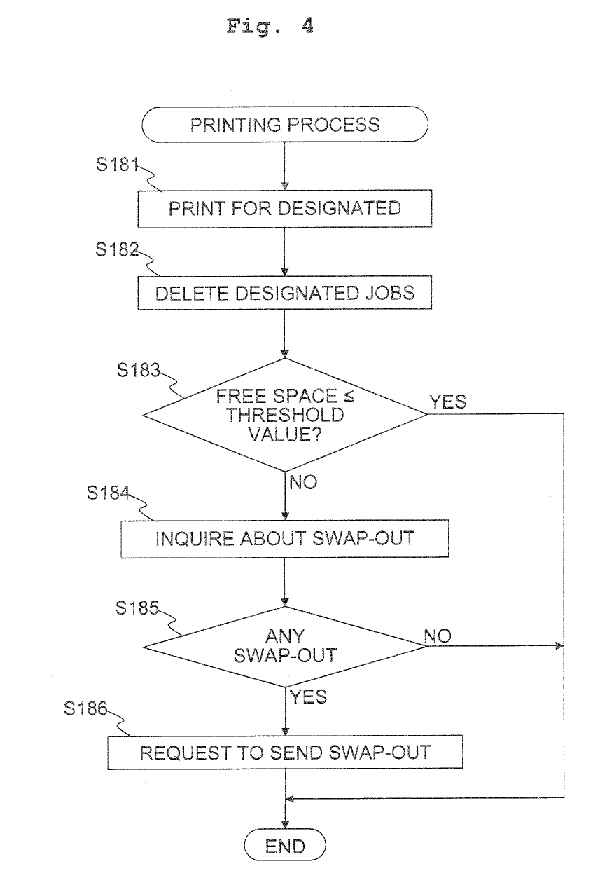

Next, referring to the flowchart of FIG. 4, explanations will be made with respect to a printing process (an example of the transmission determination section and restoring section) for carrying out printing for the print jobs stored in the memory area 110. The CPU 31 carries out the printing process on the occasion of having accepted a print instruction for the print jobs.

In the printing process, the printer 100 first starts printing for a print job (a designated job) having received the print instruction (S181). After the printing is finished, the printer 100 deletes the designated job from the memory area 110 (S182). By virtue of this, the amount of free space in the memory area 110 is increased.

Next, the printer 100 determines whether or not the amount of free space in the memory area 110 is less than or equal to the threshold value (S183). When the amount of free space in the memory area 110 is less than or equal to the threshold value (S183: Yes), then because it is not in a state capable of storing other print jobs, the printing process is ended.

On the other hand, when the amount of free space is more than the threshold value (S183: No), then it is possible to determine that there is still room for storing other print jobs into the memory area 110. Here, the printer 100 inquires of the server 300 about whether or not there are any swap-out jobs sent by the printer 100 (S184). Then, the server 300 replies to the inquiry from the printer 100 about whether or not the memory 310 of its own has stored any swap-out jobs sent in from the inquirer. For example, if there are swap-out jobs being print jobs with added swap-out information and, furthermore, those swap-out jobs are sent from the printer 100, then the server 300 outputs a reply signal indicating that there are swap-out jobs. When there are no such swap-out jobs, then it outputs a reply signal indicating that there are no swap-out jobs.

After receiving the reply from the server 300, the printer 100 determines whether or not there are any swap-out jobs in the server 300 (S185; an example of the transmission determination section). In particular, the printer 100 determines whether or not there are any swap-out jobs sent by the printer 100 to the server 300, based on the reply signal outputted from the server 300 according to the inquiry about the presence of swap-out jobs (S184). When there are no swap-out jobs in the server 300 (S185: No), then the printer 100 ends the printing process.

If there is an swap-out job in the server 300 (S185: Yes), then the printer 100 outputs a transmission request of the swap-out job to the server 300 (S186; an example of the restoring section). After outputting the transmission request of the swap-out job to the server 300 (S186), the printer 100 ends the printing process. Then, the server 300 sends the swap-out job to the printer 100 according to the transmission request from the printer 100. When there are a plurality of swap-out jobs, then the swap-out jobs may be sent, for example, in ascending order of the evacuation time. On receiving the swap-out jobs, the printer 100 carries out the aforementioned job receiving process to store the swap-out jobs into the memory area 110. By virtue of this, the print jobs once swapped-out to the server 300 are registered to the printer 100 again.

In the first embodiment, when receiving new jobs, when the free space in the memory area 110 is insufficient for storing the new jobs, then the existing print jobs stored in the memory area 110 are evacuated to the server as swap-out jobs. Then, the evacuated print jobs are deleted to allocate a sufficient amount of free space for storing the new jobs. Since the print jobs to be deleted are those lower in print priority than the new jobs, it is possible to avoid situations of failing to register the new jobs higher in print priority.

### Second Embodiment

Next, explanations will be made with respect to a different aspect of the printer for storing print jobs of high print priority. In a second embodiment, the printer 100 effects a management of the print expiration time of print jobs, sending the print jobs surpassing the print expiration time (to be referred to as the “expired jobs” hereinbelow) to the server 300 while deleting the same from the memory area 110.

Further, in the second embodiment, by issuing a command from the PC 200 to the server 300, or by operating the server 300 directly, the user is able to send the expired jobs stored in the memory 310 of the server 300 to the printer 100. That is, it is possible to send back the expired jobs on user's own will.

<Expiration Time Management Process>

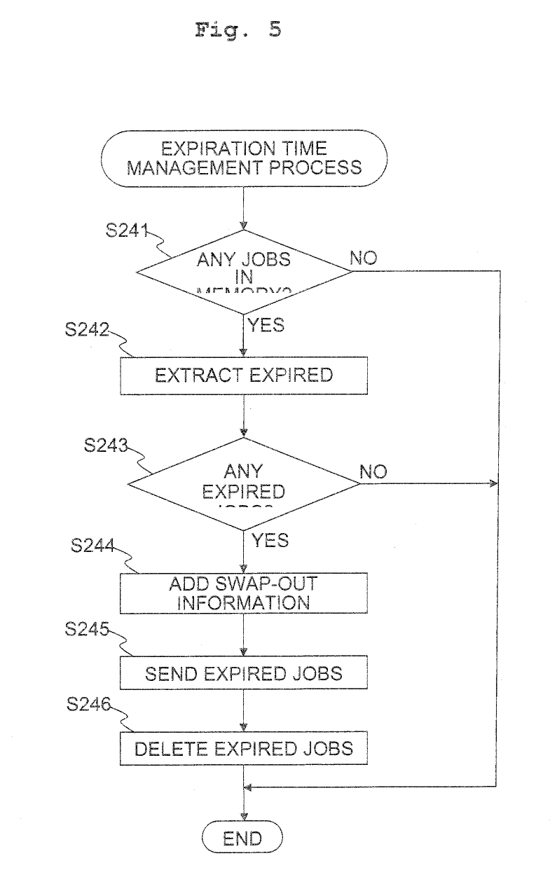

Hereinbelow, explanations will be made with respect to operation of the printer 100 in accordance with the second embodiment. First, referring to the flowchart of FIG. 5, explanations will be made with respect to an expiration time management process (an example of the second transmission section) for carrying out, in the printer 100, management of the print expiration time of the print jobs stored in the memory area 110. The CPU 31 carries out the expiration time management process in a periodic manner (every one minute, for example).

In the expiration time management process, the printer 100 first determines whether or not the memory area 110 has stored any print jobs (S241). When no print jobs are stored (S241: No), then because there are no print jobs to be managed, the expiration time management process is ended.

When some print jobs are stored (S241: Yes), then the printer 100 determines whether or not each print job stored in the memory area 110 has surpassed the print expiration time. Then, the printer 100 extracts the (expired) print jobs, if any, having surpassed the print expiration time (S242). Thereafter, the printer 100 determines whether or not the expired jobs have been extracted in the process 5242 of extracting the expired jobs (S243). When no expired jobs have been extracted (S243: No), then the printer 100 ends the expiration time management process.

When the expired jobs have been extracted (S243: Yes), then the printer 100 adds swap-out information to the extracted expired jobs (S244). The swap-out information corresponds to the information for indicating the time of swap-out and indicating that the swap-out jobs is swapped-out due to time expiration. The printer 100 adds these pieces of information to the header information of the expired jobs.

After the process (S244) of adding swap-out information to the extracted expired jobs, the printer 100 sends the expired jobs as the swap-out jobs to the server 300 (S245; an example of the transmission section). On receiving the swap-out jobs, the server 300 stores the swap-out jobs into the memory 310 of the server 300, and then notifies the printer 100 of the completion of storage.

On receiving the notification from the server 300, the printer 100 deletes the expired jobs as the swap-out jobs from the memory area 110 (S246). The aspect of deletion may be either erasion of the data or a permission of overwriting the data. After the process (S246) of deleting the expired jobs as the swap-out jobs from the memory area 110, the printer 100 ends the expiration time management process.

<Job Receiving Process>

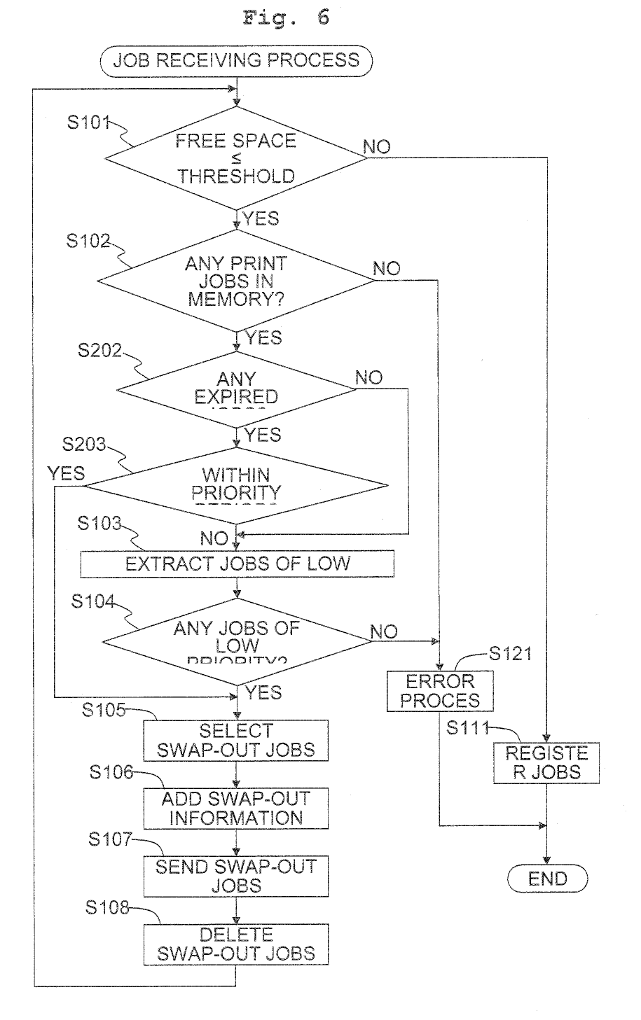

Next, referring to the flowchart of FIG. 6, explanations will be made with respect to a job reception process of the second embodiment. Note that, however, the same steps as those in the job reception process of the first embodiment are designated by the same reference numerals, any explanation of which will be omitted as appropriate. For example, the job receiving process of the second embodiment is the same as that of the first embodiment in terms of the process of determining whether or not the amount of free space in the memory area 110 is less than or equal to a threshold value (S101), and the process of determining whether or not any print jobs are stored in the memory area 110 in the case of insufficient memory (S102).

Then, when print jobs are stored in the memory area 110 (S102: Yes), then the printer 100 determines whether or not the received print jobs are expired jobs (S202). In the process of determining whether or not the received print jobs are expired jobs (S202), when the received print jobs are endowed with the evacuation information (more specifically, the information for indicating the swap-out jobs due to time expiration) added in the aforementioned expiration time management process (S244), then the printer 100 determines those print jobs to be expired jobs. When the received print jobs are not expired jobs (S202: No), then the process moves to the step of extracting print jobs of low print priority (S103) to carry out the same process as in the first embodiment.

On the other hand, when the received print jobs are expired jobs (S202: Yes), then the printer 100 determines whether or not the elapsed time since the time of sending the expired jobs to the server 300 (specifically, the swap-out time added to the swap-out information) is within a predetermined period of time (S203). Even after the printer 100 sends the expired jobs to the server 300, the user may still desire to register the expired jobs again. Then, with respect to the print jobs immediately sent over again to the printer 100 regardless of the fact that they have surpassed the print expiration time and thus been evacuated in the server 300, it is highly possible that the user strongly desires to carry out the printing. Hence, the predetermined period of time which has elapsed since the evacuation time is defined to be a priority period.

When the elapsed time since the time of sending the expired jobs to the server 300 is within the priority period (S203: Yes), then the process moves to the step of selecting swap-out jobs (S105) to select print jobs other than those received ones (the expired jobs) as the objects to become the swap-out jobs. By virtue of this, because the print jobs newly designated to be swap-out jobs are deleted from the memory area 110 after being sent to the server 300, the received expired jobs are preferentially stored into the memory area 110. On the other hand, when the aforementioned elapsed time exceeds the priority period (S203: No), then since it is not obvious whether or not the user strongly desires to carry out printing for the expired jobs, the process moves to the step of extracting print jobs lower in print priority than the received print jobs (S103) to carry out the same process as in the first embodiment.

In the second embodiment, a certain period right after sending the expired jobs is defined to be the priority period for the expired jobs, thereby raising the print priority to avoid becoming swap-out jobs again for the expired jobs received within the priority period. That is, it is conceivable that the user strongly desires to carry out printing for the jobs which were once evacuated to the server as expired jobs but sent back to the printer again within the priority period. By undertaking such kind of control, it is possible to carry out the control according to user's intention.

As explained hereinabove, when the free space in the memory area 110 becomes less, the printer 100 of the preferred embodiments allocates the space in the storage section for storing new print jobs by swapping out print jobs of low print priority to the server 300 and deleting those print jobs from the memory area 110. By virtue of this, it is possible to reduce the possibility of failing to register new print jobs while avoiding deletion of print jobs of high print priority. That is, since the print jobs of high print priority remain in the memory area 110, it is expectable to confine user's dissatisfaction. Further, since the print jobs deleted from the memory area 110 are sent to the server 300 before being deleted from the memory area 100, there is little risk in losing the print jobs and thus failing to print.

Further, the above embodiments are merely exemplifications, and thus by no means limit the present teaching. Therefore, as a matter of course, it is possible to apply various modifications and changes to the present teaching without departing from the true spirit and scope of the teaching. For example, it is also possible to apply the present teaching to multifunction printing apparatuses or copying machines instead of printers as long as they are provided with a printing function. Further, the information processing device for inputting print jobs to the printer should not be limited to a PC but may be a mobile terminal such as smartphones and the like.

Further, in the above embodiments, although printing is started through panel operation for the print jobs stored in the printer, the present teaching is not limited to this operation. Printing may as well be started, for example, on receiving a print command from the mobile terminal or through a user authentication by using a card reader and the like.

Further, in the above embodiments, although print jobs are sent directly from the PC 200 to the printer 100, the present teaching is not limited to this transmission route. Print jobs may be sent, for example, from the PC 200 to the printer 100 via the server 300.

Further, in the above embodiments, although swap-out jobs are sent to the server 300, they are not limited to this destination but may be sent, for example, to each of the PCs inputting those print jobs. Further, when there is a storage device for storing swap-out jobs, then swap-out jobs may be sent to that storage device.

Further, in the above embodiments, swap-out information is added to the swap-out jobs. By virtue of this, it is possible to first distinguish swap-out jobs from new jobs, and then distinguish the swap-out jobs due to insufficient memory from swap-out jobs due to time expiration. However, the present teaching is not limited to such kind of distinction. For example, when the printer 100 has a database for associating evacuation information with the information for identifying swap-out jobs, and storing the both, then without adding evacuation information to the swap-out jobs, the above distinction is still possible by referring to the database.

Further, in the step of extracting print jobs lower in print priority than the received new print jobs (S103) of the job receiving process (FIG. 3) of the first embodiment, the expired jobs may be preferentially extracted as in the step of extracting the expired jobs (S242) of the expiration time management process (FIG. 5) of the second embodiment, or as in the step of determining whether or not the received print jobs are expired jobs (S202) of the job reception process (FIG. 6) of the second embodiment.

What is claimed is:

1. A printing apparatus which is communicably connected to an external device that is independent from the printing apparatus and which performs printing on a medium based on a print job, the printing apparatus comprising:
a storage section which is configured to store a plurality of print jobs;
a printing section which is configured to perform printing to execute a print job of the print jobs stored in the storage section by accepting a print instruction for the print job;
a priority determination section which is configured to determine a print priority for each of the print jobs stored in the storage section under a condition that an amount of free space in the storage section is not more than a threshold value;
a transmission section which is configured to transmit, to the external device, a low-priority print job of the print jobs of which priority is determined, to be lower than that of other print jobs among the print jobs by the priority determination section; and
a deletion section which is configured to delete, from the storage section, the low-priority print job transmitted by the transmission section.

2. The printing apparatus according to claim 1, wherein under a condition that the amount of free space in the storage section becomes not more than the threshold value because of receiving a new print job, the priority determination section determines whether or not the print priority of each of the print jobs stored in the storage section is higher than a print priority of the new print job.

3. The printing apparatus according to claim 2, wherein among the print jobs stored in the storage section, the priority determination section determines a print priority of a print job of a same user with the new print job to be lower than a print priority of a print job of a different user with the new print job.

4. The printing apparatus according to claim 2, wherein in a case that the new print job is same as the low-priority print job transmitted by the transmission section, the priority determination section determines the print priority of the new print job to be higher than the print priority of each of the print jobs stored in the storage section.

5. The printing apparatus according to claim 1, wherein a print expiration time is set in each of the print jobs stored in the storage section; and in a case in which a print job stored in the storage section has surpassed the print expiration time, then the priority determination section determines the expired print job to be lower in print priority than the print jobs which have not surpassed the print expiration time.

6. The printing apparatus according to claim 1, wherein a print expiration time is set in each of the print jobs stored in the storage section; and the priority determination section determines a print priority of a print job with a first period of time before a print expiration time is expired to be higher than a print priority of a print job with a second period of time before a print expiration time is expired, the second period of time being longer than the first period of time.

7. The printing apparatus according to claim 1, wherein the priority determination section determines a print priority of a print job received within a priority period which is provided to raise the print priority to be higher than the print priority of the print jobs received during a period which is not the priority period.

8. The printing apparatus according to claim 7 wherein a print expiration time is set in each of the print jobs stored in the storage section;
the printing apparatus further comprises a second transmission section which is configured to transmit a print job having surpassed the print expiration time; and
the priority period for the print job transmitted by the second transmission section is defined to be a predetermined period of time elapsed since the second transmission section transmits the print job.

9. The printing apparatus according to claim 1 further comprising:
a transmission determination section which is configured to determine whether or not there is a swap-out job which is the low-priority print job transmitted by the transmission section, after the printing section performs printing to execute one of the print jobs; and
a restoring section which is configured to store the swap-out job into the storage section under a condition that the transmission determination section has determined that there is the swap-out job.

10. The printing apparatus according to claim 1, wherein under a condition that the transmission section transmits the print job, the transmission section adds information to the print job for identifying the print job as transmitted by the transmission section.

11. The printing apparatus according to claim 2, wherein the priority determination section, the transmission section, and the deletion section are configured to repeat: determining the print priority for the print jobs stored in the storage section; transmitting the low-priority print job to the external device in a case in which the priority determination section has determined that the low-priority print job to be lower in the print priority than other print jobs; and deleting the low-priority print job transmitted by the transmission section from the storage section, until the amount of free space in the storage section becomes greater than the predetermined value even though the new print job is received.

12. A printing system which is configured to start printing to execute print jobs by accepting a print instruction for the print jobs, the printing system comprising:
a printing apparatus which performs printing for the print jobs; and
an external device which is configured to communicates with the printing apparatus, and which is independent from the printing apparatus,
wherein the printing apparatus includes:
a storage section which is configured to store the print jobs;
a priority determination section which is configured to compare the print jobs stored in the storage section with a new print job to determine whether or not the print jobs stored in the storage section are higher in print priority than the new print job under a condition that the amount of free space in the storage section becomes not more than a predetermined value because of receiving the new print job;
a transmission section which is configured to transmit a low-priority print job to the external device in a case in which the priority determination section has determined that the low-priority print job to be lower in the print priority than other print jobs among the print jobs;
a deletion section which is configured to delete the low-priority print job sent by the transmission section from the storage section;
a transmission determination section which is configured to determine whether or not there is a swap-out job which is the low-priority print job transmitted by the transmission section, after executing the print jobs stored in the storage section; and
a request section which is configured to request the external device to send the swap-out job under a condition that the transmission determination section has determined that there is the swap-out job; and
wherein the external device includes: an external storage section which is configured to store the swap-out job, and a job transmission section which is configured to transmit the swap-out job stored in the external storage section to the printing apparatus according to the request from the request section.

13. A printing apparatus which performs printing on a medium based on a print job, comprising:
a communicating section which is configured to communicate with an external apparatus which is independent from the printing apparatus;
a storage section which is configured to store a plurality of print jobs;
a printing section which is configured to perform printing onto the medium based on each of the print jobs; and
a control section which is configured to control the communicating section, the storage section and the printing section;
wherein the control section is configured to perform steps under a condition that the communicating section receives a new print job, the steps including:
checking an amount of free space in the storage section;
selecting, based on a predetermined condition, a lowest-priority print job of which priority is the lowest in the print jobs stored in the memory section, under a condition that the amount of free space in the storage section is not greater than a threshold value;
transmitting the lowest-priority print job to the external apparatus by the communicating section; and
deleting, from the storage section, the lowest-priority print job transmitted to the external apparatus.

14. The printing apparatus according to claim 13, wherein under a condition that the amount of free space in the storage section becomes not more than the threshold value because of receiving the new print job, the control section determines whether or not the print priority of each of the print jobs stored in the storage section is higher than a print priority of the new print job.

15. The printing apparatus according to claim 14, wherein among the print jobs stored in the storage section, the control section determines a print priority of a print job of a same user with the new print job to be lower than a print priority of a print job of a different user with the new print job.

16. The printing apparatus according to claim 14, wherein in a case that the new print job is same as the low-priority print job transmitted by the communicating section, the control section determines the print priority of the new print job to be higher than the print priority of each of the print jobs stored in the storage section.

17. The printing apparatus according to claim 13, wherein the control section sets a print expiration time for each of the print jobs stored in the storage section; and
in a case in which a print job stored in the storage section has surpassed the print expiration time, then the control section determines the expired print job to be lower in print priority than the print jobs which have not surpassed the print expiration time.

18. The printing apparatus according to claim 13, wherein the control section sets a print expiration time for each of the print jobs stored in the storage section; and
the control section determines a print priority of a print job with a first period of time before a print expiration time is expired to be higher than a print priority of a print job with a second period of time before a print expiration time is expired, the second period of time being longer than the first period of time.

19. The printing apparatus according to claim 13, wherein the control section determines a print priority of a print job received within a priority period which is provided to raise the print priority to be higher than the print priority of the print jobs received during a period which is not the priority period.

20. The printing apparatus according to claim 19 wherein the control section sets a print expiration time for each of the print jobs stored in the storage section;
the printing apparatus further comprises a second communicating section which is configured to transmit a print job having surpassed the print expiration time; and
the control section defines the priority period for the print job transmitted by the second transmission section as a predetermined period of time elapsed since the second transmission section transmits the print job.
